(19) United States
(12) Patent Application Publication
(10) Pub. No.: US 2008/0296981 A1
(43) Pub. Date: Dec. 4, 2008

(54) Remote structure utility control (RSUC)

(76) Inventor: David Yaakov, Gaithersburg, MD (US)

Correspondence Address: David Yaakov, 429-A East Diamond Ave., Gaithersburg, MD, 20877, US

(21) Appl. No.: 11/633,101

(22) Filed: May 29, 2007

(51) Int. Cl. H99Z 99/00

(52) U.S. Cl. 307/149

(57) ABSTRACT

The Remote Structure Utility control (RSUC) is a devise that is placed in a home or business that allows the user to turn the power on and off to different outlets remotely. The power can be turned on and off by using a cell phone, a landline, or the internet.

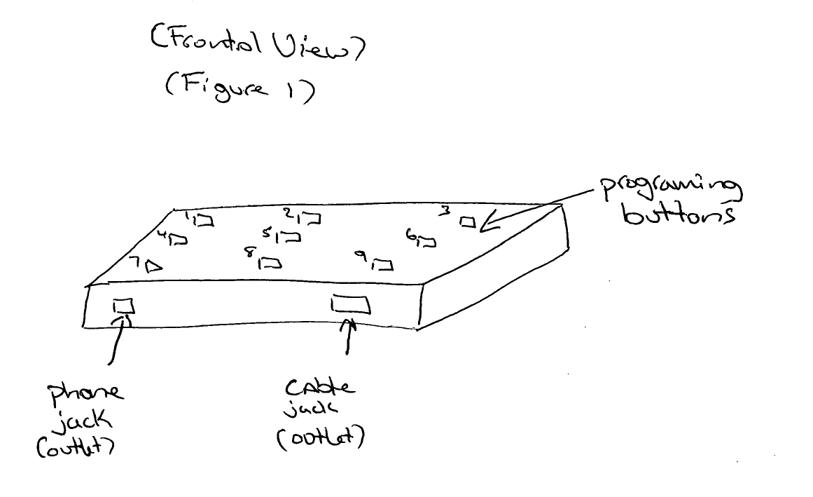

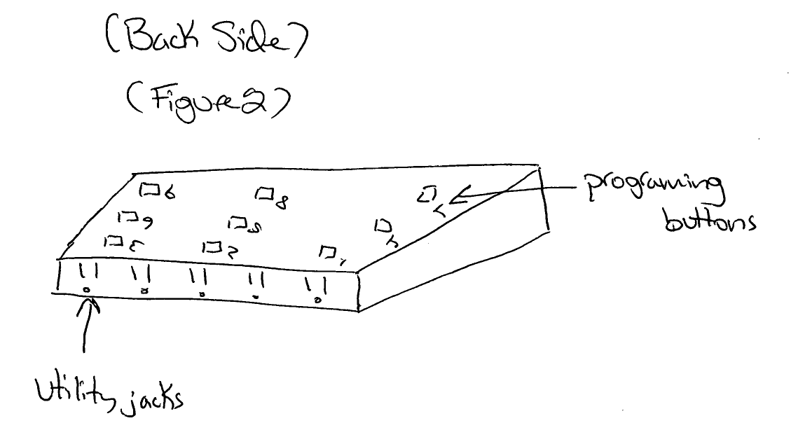

This invention is called the Remote Structure Utility Control (RSUC). It is a device that can vary in sizes but most commonly will be the size of a small answering machine. It has jacks for phone lines or high speed cable on one side and outlets for various utilities on the other side. It is most commonly made out of plastic, with a few buttons that program each outlet. The RSUC is very user friendly, by just pushing a few buttons, call the RSUC by phone, or connecting to it via internet cable, whichever is currently hooked to it, you can control it and the various utilities hooked up to it.

This specification contains no new matter.

### Manner and Process of Making and Using:

This machine could be made using a circuit board and diodes which distinguish the different commands given by the buttons or button tones, although this machine is not limited to being made of a circuit board and diodes. To use the machine you would need to read the instructions thoroughly, but in a brief explanation you would push a button which in turn would feed power to its corresponding outlet, you could also call the phone number the phone line is hooked to, or go online to the web address given to the high speed cable that is hooked to the RSUC. If calling by phone push the button to the corresponding outlets you wish to turn on or off, if online type in which outlet you wish turned on or off.

### BRIEF DESCRIPTION OF THE SEVERAL VIEWS OF THE DRAWINGS

FIG. (1) shows the frontal view of the RSUC with the phone and cable outlets, and programming buttons.

FIG. (2) shows the backside of the RSUC with the utility outlets and programming buttons on top.

1. I David Yaakov distinctly claim this Remote Structure Utility Control to be my sole invention. No other person or entity has taken part in this invention or the idea for this invention. All of the subject matter herein is my invention.
